(19) United States
(12) Patent Application Publication
(10) Pub. No.: US 2019/0104353 A1
(43) Pub. Date: Apr. 4, 2019

(54) HEADPHONE

(71) Applicant: RION Co., Ltd., Tokyo (JP)

(72) Inventors: Shinichi ISHIKAWA, Tokyo (JP); Takashi YAMASAKI, Tokyo (JP); Kenichi NAGAMINE, Tokyo (JP); Takashi MANO, Tokyo (JP)

(21) Appl. No.: 16/120,817

(22) Filed: Sep. 4, 2018

(30) Foreign Application Priority Data
Oct. 4, 2017 (JP) 2017-194509

(51) Int. Cl. H04R 1/10

(52) U.S. Cl. CPC H04R 1/1008; H04R 1/1083; H04R 1/1058

(57) ABSTRACT

A headphone includes: a sound source configured to convert an electric signal into a sound and to output the sound; a body portion covering a back surface of the sound source and holding the sound source; an ear pad which is configured to surround the pinna of a wearer, and which forms an air space between the wearer's head and the sound source when the headphone is worn; a sound absorbing material disposed opposing the sound source at a front surface of the sound source in the air space; and a holder holding the ear pad and the sound absorbing material. The holder is attachable to and detachable from the body portion.

### CROSS-REFERENCE TO RELATED APPLICATION

This application claims priority from Japanese Patent Application No. 2017-194509 filed with the Japan Patent Office on Oct. 4, 2017, the entire content of which is hereby incorporated by reference.

### BACKGROUND

### 1. Technical Field

The present disclosure relates to a headphone.

### 2. Related Art

Known headphones include various types, such as a circum-aural type and a supra-aural type. A circum-aural type headphone covers the pinna of the wearer so as to enclose the pinna. A supra-aural type headphone is placed over the pinna. An example of the circum-aural type headphone is disclosed in JP-A-2016-015691. The headphone disclosed in JP-A-2016-015691 is provided with: a headphone unit which outputs sound; a housing covering the back surface of the headphone unit; and an ear pad covering the pinna of the wearer. Further, the housing includes a base material formed of a plate member having sound absorbability and acoustic resistance. The base material allows for easy adjustment of the acoustic resistance value of the housing. In another example, JP-A-2011-160310 discloses a headphone provided with: a speaker unit; an ear cup covering the back surface of the speaker unit; an ear pad covering the pinna of the wearer; and a doughnut-shaped buffer material. The speaker unit is attached to a baffle plate having a rib-shaped wall. The doughnut-shaped buffer material is disposed on the inside of the rib-shaped wall. Thus, the doughnut-shaped buffer material is disposed between the baffle plate and the ear pad. In the headphone disclosed in JP-A-2011-160310, even if the ear pad is crushed due to lateral pressure that may be applied when worn, the volume of a front air space enclosed by the baffle plate and the ear pad is ensured by means of the rib-shaped wall and the buffer material. Accordingly, the sound quality of low to medium frequency bands can be improved. Thus, various circum-aural type headphones adapted for different purposes have been proposed.

### SUMMARY

A headphone includes: a sound source configured to convert an electric signal into a sound and to output the sound; a body portion covering a back surface of the sound source and holding the sound source; an ear pad which is configured to surround the pinna of a wearer, and which forms an air space between the wearer's head and the sound source when the headphone is worn; a sound absorbing material disposed opposing the sound source at a front surface of the sound source in the air space; and a holder holding the ear pad and the sound absorbing material. The holder is attachable to and detachable from the body portion.

### BRIEF DESCRIPTION OF THE DRAWINGS

FIG. 1 is a vertical cross sectional diagram of an embodiment of a headphone unit of headphones according to the present disclosure;

FIG. 2A is a view of a body portion viewed along arrows A-A of FIG. 1;

FIG. 2B is a view of an ear pad viewed along arrows B-B of FIG. 1;

FIG. 3A to FIG. 3C are diagrams for describing the influence of the position of the pinna in the ear pad on frequency characteristics, FIG. 3A illustrating the position of the pinna with respect to the ear pad, FIG. 3B illustrating the relationship between the position of the pinna and frequency characteristics in a case where headphones using the headphone unit of FIG. 1 are not provided with sound absorbing material, and FIG. 3C illustrating the relationship between the position of the pinna and frequency characteristics in a case where the headphones are provided with sound absorbing material; and

FIG. 4A and FIG. 4B are diagrams for describing the influence of reflected sound during an acoustic characteristics measurement, FIG. 4A schematically illustrating an acoustic characteristics measurement method in accordance with IEC60318-1, and FIG. 4B illustrating the measurement results obtained by measuring frequency characteristics by the method of FIG. 4A using headphones provided with the headphone unit of FIG. 1, when the headphones are provided with sound absorbing material and when not provided with sound absorbing material.

### DESCRIPTION OF EMBODIMENTS

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

When circum-aural type headphones are used for testing with an audiometer, loudness of the test sound heard/received by a test subject may vary depending on the position of the pinna in the ear pad of the headphones being worn. This may result in a failure to achieve testing result reproducibility. In addition, during an acoustic characteristic measurement or hearing test, reflected sound may be produced in an air space enclosed by the wearer's head and the ear pad of the headphones being worn. The influence of the reflected sound may destabilize high-frequency characteristics.

An object of an embodiment of the present disclosure is to solve the above problems. The purpose of an embodiment of the present disclosure is to provide a headphone with which, even if the position of the pinna in the ear pad of the headphone being worn is changed, variations in loudness of sound heard/received by a wearer can be suppressed, and with which stable high-frequency characteristics can be obtained.

A headphone according to an embodiment of the present disclosure includes: a sound source configured to convert an electric signal into a sound and to output the sound; a body portion covering a back surface of the sound source and holding the sound source; an ear pad which is configured to surround the pinna of a wearer, and which forms an air space between the wearer's head and the sound source when the headphone is worn; a sound absorbing material disposed opposing the sound source at a front surface of the sound source in the air space; and a holder holding the ear pad and the sound absorbing material. The holder is attachable to and detachable from the body portion.

In the headphone described above, the sound absorbing material preferably covers an entire front surface of the sound source, and separates the air space on the wearer's head side from the sound source.

In order to allow the holder to be attached to or detached from the body portion, one of the body portion and the holder includes a hook portion, and the other thereof is provided with an insertion hole into which the hook portion is insertable, and a locking hole which is continuous with the insertion hole, and which locks the hook portion when, with the hook portion inserted into the insertion hole, the holder is rotated relative to the body portion. Further, one of the body portion and the holder preferably includes a recess, and the other of the body portion and the holder is preferably provided with an elastic piece having a projection fittable to the recess. Preferably, the elastic piece, when the holder is attached to the body portion, is deformed by warping and then recovers as the projection fits into the recess.

According to the headphones of the embodiment of the present disclosure with the configuration described above, it becomes possible to suppress variations in loudness of sound heard/received by a wearer even if the position of the pinna in the ear pad of the headphones being worn is changed. It also becomes possible to obtain stable high-frequency characteristics.

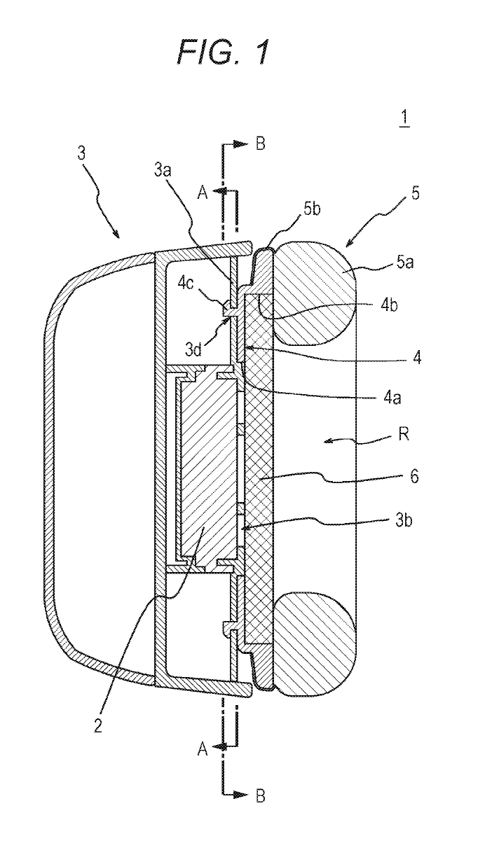

In the following, an embodiment of the headphones of the present disclosure will be described with reference to the drawings. The headphones according to the present embodiment are provided with the headphone unit 1 illustrated in FIG. 1, and a head band which is not illustrated. The head band has the headphone unit 1 disposed on each of the right and left ends thereof. The following description will focus on the headphone unit 1. In the following description, a “front surface” refers to the side of the members closer to the wearer's ear, and a “back surface” refers to the side of the members farther from the wearer's ear. For example, in FIG. 1, the right side corresponds to the front surface side, and the left side corresponds to the back surface side.

The headphone unit 1 generally includes a sound source 2, a body portion 3, a holder 4, an ear pad 5, and a sound absorbing material 6.

The sound source 2 converts an electric signal output from, e.g., an audiometer or a music playback device into a sound, and outputs the sound. A sound source of various drive systems may be employed as the sound source 2. Examples of the sound source of various drive systems include a dynamic-type and a capacitive-type. In the dynamic-type, a voice coil is driven in response to the input of an electric signal, whereby a vibration plate vibrates and sound is emitted.

The body portion 3 covers the back surface of the sound source 2 and also holds the sound source 2. In the present embodiment, the body portion 3 has a dome-shaped exterior. The body portion 3 may accommodate the sound source 2 and various other members (not illustrated).

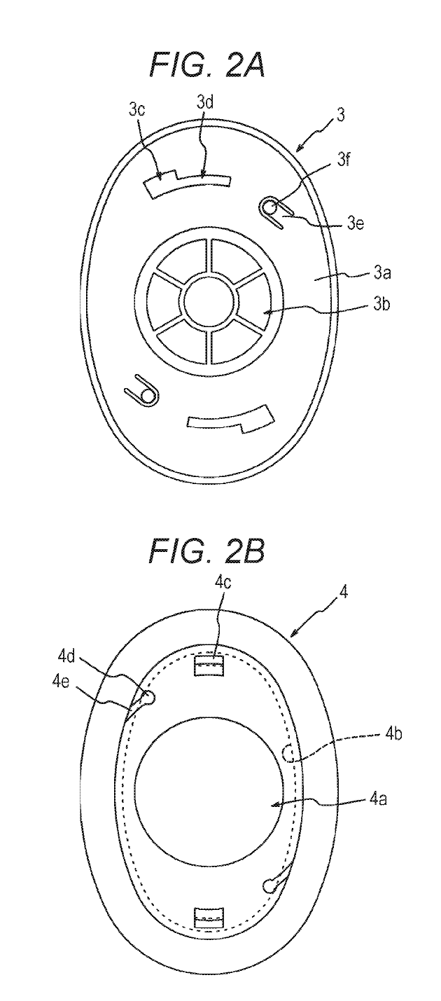

The body portion 3 has a front surface provided with a panel 3a. In the present embodiment, the panel 3a, as illustrated in FIG. 2A, has an elongated, substantially elliptical shape, for example. The panel 3a has a panel opening 3b at the center. The panel opening 3b is open with respect to the sound source 2. The panel 3a has insertion holes 3c provided in the vicinity of the outer edge in the longitudinal direction thereof. The insertion holes 3c penetrate the panel 3a. Further, locking holes 3d are provided next to the insertion holes 3c (on the panel opening 3b side). The locking holes 3d penetrate the panel 3a and are continuous with the insertion holes 3c. The length of the locking holes 3d in a direction from the inside to the outside of the panel 3a is smaller than that of the insertion holes 3c. U-shaped penetrating grooves extend adjacent to the locking holes 3d, penetrating the panel 3a. The penetrating grooves form elastic pieces 3e on the inside thereof. The elastic pieces 3e are configured to be supported on the panel 3a in a cantilever fashion. The elastic pieces 3e have spherical projections 3f at the distal end thereof. The projections 3f protrude toward the holder 4 in the headphone unit 1 as assembled. In the present embodiment, the headphone unit 1 includes a pair of insertion holes 3c, a pair of locking holes 3d, a pair of elastic pieces 3e, and a pair of projections 3f. The pair of insertion holes 3c is arranged symmetrically with respect to the center of the panel 3a. The pair of locking holes 3d is arranged symmetrically with respect to the center of the panel 3a. The pair of elastic pieces 3e is arranged symmetrically with respect to the center of the panel 3a. The pair of projections 3f is arranged symmetrically with respect to the center of the panel 3a.

As illustrated in FIG. 1, the holder 4 is disposed on the front surface of the panel 3a. As illustrated in FIG. 2B, the holder 4 is formed in an elongated, substantially elliptical shape. The holder 4 has a circular holder opening 4a at the center thereof. The holder opening 4a is greater than the outer diameter of the sound source 2. An accommodating portion 4b is provided on the outside of the holder opening 4a and on the front surface side of the holder 4. The accommodating portion 4b has a recessed, substantially elliptical shape. The accommodating portion 4b accommodates the sound absorbing material 6. The holder 4 has hook portions 4c on the back surface thereof. The hook portions 4c have an L-shaped vertical cross section, as illustrated in FIG. 1. As illustrated in FIG. 2B, recesses 4d and grooves 4e are provided next to the hook portions 4c. The recesses 4d are fittable to the projections 3f. The grooves 4e are continuous with the recesses 4d. The holder 4 includes a pair of hook portions 4c, a pair of recesses 4d, and a pair of grooves 4e. The pair of hook portions 4c is arranged symmetrically with respect to the center of the holder 4. The pair of recesses 4d is arranged symmetrically with respect to the center of the holder 4. The pair of grooves 4e is arranged symmetrically with respect to the center of the holder 4.

The ear pad 5 is provided with an ear pad body portion 5a. The ear pad body portion 5a is positioned on the front surface of the holder 4, and configured to surround the pinna of the wearer. In the present embodiment, the ear pad body portion 5a has a substantially elliptical doughnut-shape (form) along the edge of holder 4. The ear pad body portion 5a is formed by, for example, stuffing elastic material (such as sponge) on the inside of the skin of the ear pad body portion 5a. When the headphones are worn, the ear pad body portion 5a encloses the pinna and closely attaches to the wearer's head. That is, when the headphones are worn, an air space R enclosed by the ear pad body portion 5a is formed between the wearer's head and the sound source 2. The ear pad 5 is provided with a stretchable and annular locking portion 5b continuous with the skin of the ear pad body portion 5a. The locking portion 5b is hooked on the back surface of the holder 4 so as to cover the edge of the holder 4 while the ear pad body portion 5a is disposed on the front surface of the holder 4. In this way, the ear pad 5 is detachably held onto the holder 4.

The sound absorbing material 6 is formed of a material configured to absorb or dampen sound energy. Specifically, the sound absorbing material 6 includes a porous material providing the effect of converting sound energy into thermal energy by repeatedly reflecting sound vibrating waves in continuous pores between the front and back thereof. Examples of such material include non-woven cloth, glass wool, and sponges. As illustrated in FIG. 1, the sound absorbing material 6 is disposed in the air space R. The sound absorbing material 6 is opposed to the sound source 2 at a front surface of the sound source 2. In the present embodiment, the sound absorbing material 6 is formed in a substantially elliptical shape corresponding to the accommodating portion 4b of the holder 4. The sound absorbing material 6 accommodated in the accommodating portion 4b covers the entire front surface area of the sound source 2, and separates the air space R on the wearer's head side from the sound source 2.

The ear pad 5 and the sound absorbing material 6 having the above configuration are provided in the headphone unit 1 as follows. The sound absorbing material 6 is accommodated in the accommodating portion 4b. Then, the ear pad body portion 5a is arranged on the front surface of the holder 4. Further, the locking portion 5b is hooked onto the back surface of the holder 4. In this way, the ear pad 5 and the sound absorbing material 6 are held onto the holder 4. Then, the hook portions 4c of the holder 4 are inserted into the insertion holes 3c of the panel 3a. The holder 4 is then rotated relative to the panel 3a, whereby the hook portions 4c are locked in the locking holes 3d. Thus, the headphone unit 1 is assembled. Accordingly, the ear pad 5 and the sound absorbing material 6 can be integrally attached to the body portion 3 by means of the holder 4. Thus, the attaching operation can be easy. The materials of the ear pad 5 and the sound absorbing material 6 tend to easily deteriorate over time. The ear pad 5 may also be damaged during use. Accordingly, the ear pad 5 and the sound absorbing material 6 are preferably regularly replaced after a predetermined period (such as one year). The above-described configuration makes the replacement of the ear pad 5 and the sound absorbing material 6 easy. When the hook portions 4c are inserted into the insertion holes 3c, the projections 3f abut on the back surface of the holder 4, and the hook portions 4c become deformed by warping. Meanwhile, as the holder 4 is rotated relative to the panel 3a in order to lock the hook portions 4c in the locking holes 3d, the projections 3f move along the grooves 4e and fit into the recesses 4d. As a result, the hook portions 4c that have been deformed by warping recover. With this configuration, a clicking feel can be created. That is, while the locking of the hook portions 4c in the locking holes 3d is not visible from the outside, the clicking feel makes it possible to recognize that the hook portions 4c have been locked into the locking holes 3d.

When the headphones having the above-described configuration but without the sound absorbing material 6 are used for testing with an audiometer, the loudness of the test sound heard/received by a test subject may vary depending on the position of the pinna in the ear pad of the headphones being worn. As a result, testing result reproducibility may fail to be obtained. In addition, during an acoustic characteristic measurement or a hearing test, high-frequency characteristics may be destabilized due to the influence of reflected sound produced in the air space R.

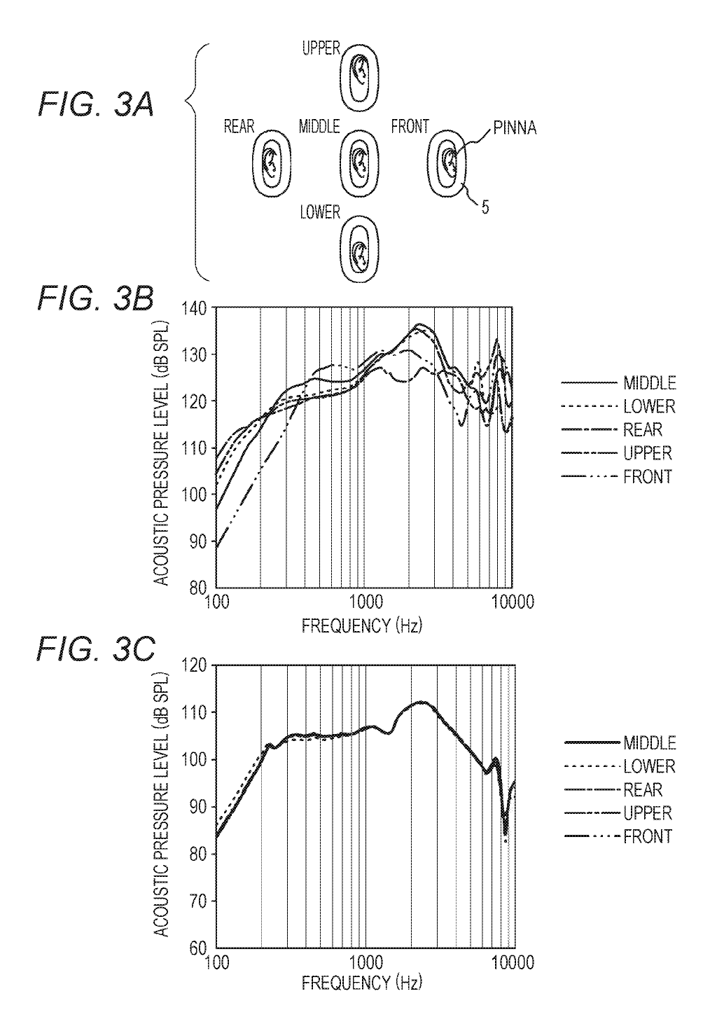

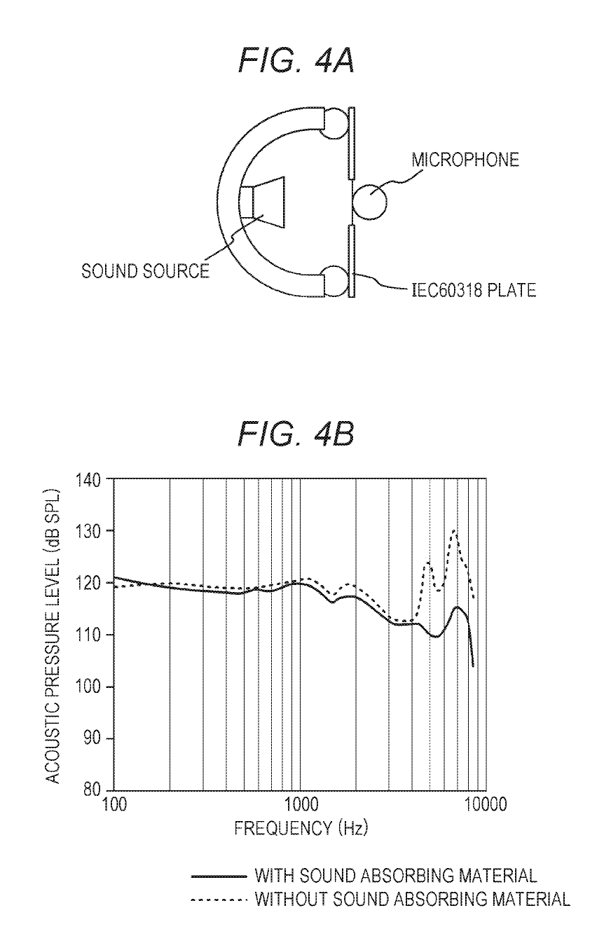

These phenomena will be described with reference to FIGS. 3A, B, C, and FIGS. 4A, B. FIGS. 3A, B, C are diagrams for describing the influence of the position of the pinna in the ear pad on frequency characteristics. For frequency characteristic measurement, a mannequin called a head and torso simulator (HATS; known as KEMAR (registered trademark) from GRAS Sound & Vibration A/S) is used. A predetermined electric signal is input to the headphones worn on the mannequin. The frequency of a sound output from the sound source 2 is varied in a 100-10000 Hz range, and acoustic pressure levels are measured using a microphone via a coupler (Zwislocki coupler). Herein, the position of the pinna of the HATS with respect to the ear pad 5 is defined as follows. As illustrated in FIG. 3A, the state in which the pinna of the HATS is positioned at substantially the center of the ear pad 5 is defined as “middle”. The states in which the pinna is positioned at the upper side and lower side of the ear pad 5 are respectively defined as “upper” and “lower”. The states in which the pinna is positioned to the rear side and front side of the ear pad 5 are respectively defined as “rear” and “front”.

Using the headphones without the sound absorbing material 6, measurements were taken. As a result, as illustrated in FIG. 3B, it has been recognized that the acoustic pressure level measured greatly changes in accordance with a change in the position of the pinna of the HATS with respect to the ear pad 5. This means that the frequency characteristics are varied depending on the position of the pinna in the ear pad 5 when worn. Accordingly, during a testing with an audiometer, there is a possibility not to obtain testing results with good reproducibility. On the other hand, when measurements were taken using the headphones provided with the sound absorbing material 6, as illustrated in FIG. 3C, it has been recognized that the acoustic pressure level measured hardly changes even when the position of the pinna of the HATS is changed with respect to the ear pad 5. That is, it has been recognized that stable frequency characteristics can be obtained. Thus, when the sound absorbing material 6 is disposed opposing the sound source 2 in the air space R, it becomes possible to suppress variations in loudness of sound heard/received by a wearer even if the position of the pinna in the ear pad 5 is changed when the headphones are worn. During the measurements relating to FIG. 3C, polyester non-woven cloth (Himelon SN50B from AMBIC CO., LTD. (total thickness: 7.5 mm)) was used as the sound absorbing material 6.

FIGS. 4A, B are diagrams for describing the influence of reflected sound during acoustic characteristic measurement. In the present measurement, acoustic characteristics were measured by a method in accordance with IEC60318-1. Specifically, as schematically illustrated in FIG. 4A, measurements were taken with a plate disposed between the sound source of the headphones and a microphone. A predetermined electric signal was input to the headphones set as illustrated in FIG. 4A, in which the sound absorbing material 6 was not provided. Further, the frequency of a sound output from the sound source 2 was varied in a 100-10000 Hz range when acoustic pressure levels were measured using the microphone. As a result, as indicated by a dashed line in FIG. 4B, it has been recognized that when the frequency is not less than 4 kHz, the acoustic pressure level greatly changes due to the influence of reflected sound caused by the plate. On the other hand, when acoustic measurement was taken using the headphones provided with the sound absorbing material 6 that was used during the measurement relating to FIG. 3C, it has been recognized that, as indicated by a solid line in FIG. 4B, the change in acoustic pressure level can be also suppressed in high frequencies. Thus, when the sound absorbing material 6 is disposed opposing the sound source 2 in the air space R, stable high-frequency characteristics can be obtained. While the shape of the pinna may vary from one person to another, the influence of reflected sound can be suppressed by means of the sound absorbing material 6. Accordingly, variations due to pinna shape differences can also be reduced during a hearing test with an audiometer.

While an embodiment of the headphones according to the present disclosure has been described, the present disclosure is not limited to the embodiment. The present disclosure may include various modifications within the scope of the claims. In the present embodiment, for example, the panel 3a is provided with the insertion holes 3c and the locking holes 3d while the holder 4 is provided with the hook portions 4c. Alternatively, the panel 3a may be provided with the hook portions while the holder 4 may be provided with the insertion holes and the locking holes. The elastic pieces 3e and the projections 3f of the panel 3a may be provided in the holder 4 while the recesses 4d and the grooves 4e of the holder 4 may be provided in the panel 3a. Further, while the embodiment has been described focusing on the case for testing with an audiometer, the headphones according to the present disclosure may be used for various other purposes, such as for listening to music.

The embodiments of the present disclosure may include first to fourth headphones as follows.

The first headphone includes: a sound source configured to convert an electric signal into a sound and to output the sound; a body portion covering a back surface of the sound source and holding the sound source; an ear pad which has a form surrounding the pinna of a wearer, and which forms an air space between the wearer's head and the sound source when worn; a sound absorbing material which is disposed opposing the sound source at a front surface of the sound source in the air space; and a holder holding the ear pad and the sound absorbing material, the holder being attachable to and detachable from the body portion.

The second headphone is the first headphone in which the sound absorbing material covers an entire front surface of the sound source, and separates the air space on the wearer's head side from the sound source.

The third headphone is the first or the second headphone in which one of the body portion and the holder includes a hook portion, and the other thereof includes an insertion hole into which the hook portion is inserted, and a locking hole which is continuous with the insertion hole and which locks the hook portion when, with the hook portion inserted into the insertion hole, the holder is rotated relative to the body portion.

The fourth headphone is one of the first to third headphones in which one of the body portion and the holder includes a recess, and the other thereof includes an elastic piece having a projection fittable to the recess, in which the elastic piece, when the holder is attached to the body portion, is deformed by warping and then recovers as the projection fits into the recess.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. A headphone comprising:
a sound source configured to convert an electric signal into a sound and to output the sound;
a body portion covering a back surface of the sound source and holding the sound source;
an ear pad which is configured to surround the pinna of a wearer, and which forms an air space between the wearer's head and the sound source when the headphone is worn;
a sound absorbing material disposed opposing the sound source at a front surface of the sound source in the air space; and
a holder holding the ear pad and the sound absorbing material, wherein
the holder is attachable to and detachable from the body portion.

2. The headphone according to claim 1, wherein the sound absorbing material covers an entire front surface of the sound source, and separates the air space on the wearer's head side from the sound source.

3. The headphone according to claim 1, wherein
one of the body portion and the holder includes a hook portion, and
the other of the body portion and the holder includes an insertion hole into which the hook portion is insertable, and a locking hole which is continuous with the insertion hole and which locks the hook portion when, with the hook portion inserted into the insertion hole, the holder is rotated relative to the body portion.

4. The headphone according to claim 1, wherein
one of the body portion and the holder includes a recess,
the other of the body portion and the holder includes an elastic piece having a projection fittable to the recess, and
the elastic piece, when the holder is attached to the body portion, is deformed by warping and then recovers as the projection fits into the recess.
